(19) United States
(12) Patent Application Publication
(10) Pub. No.: US 2007/0081099 A1
(43) Pub. Date: Apr. 12, 2007

(54) Display apparatus and method for controlling the same

(75) Inventors: Young-hwa Yun, Seoul (KR); Sung-youn Pak, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/541,646

(22) Filed: Oct. 3, 2006

(30) Foreign Application Priority Data
Oct. 8, 2005 (KR) 10-2005-0094673

(51) Int. Cl. H04N 5/50

(52) U.S. Cl. 348/569

(57) ABSTRACT

Disclosed are a display apparatus and a method for controlling the display apparatus. The method for controlling a display apparatus including a user selection unit for operating an adjustment item having at least one main adjustment item and at least one sub adjustment item corresponding to the main adjustment item, the method including displaying each main adjustment item in one direction when a user adjustment function is selected through the user selection unit; and displaying the sub adjustment item in the same direction as the main adjustment item while distinguishing the sub adjustment item from the main adjustment item when the main adjustment item having the sub adjustment item is selected through the user selection unit.

### CROSS-REFERENCE TO RELATED APPLICATIONS

This application claims priority from Korean Patent Application No. 2005-0094673, filed on Oct. 8, 2005, in the Korean Intellectual Property Office, the disclosure of which is incorporated herein its in entirety by reference.

### BACKGROUND OF INVENTION

1. Field of Invention

The present invention relates to a display apparatus and a method for controlling the same, and more particularly, to a display apparatus having a user adjustment menu and a method for controlling the same.

2. Description of the Related Art

A general display apparatus, such as a television, a monitor and a plasma display panel (PDP) apparatus, displaying an image comprises a display unit on which an image is displayed, a signal processing unit for processing an input video signal and converting the processed video signal to be displayed on the display unit, and a control unit controlling the display unit and the signal processing unit.

Meanwhile, information provided to a user through the display apparatus becomes gradually diverse. In order to display the various information on the display unit, the conventional display apparatus has a complicated menu which is displayed on the display unit, so that a user may feel an inconvenience in operating the menu.

### SUMMARY OF THE INVENTION

An aspect of the present invention provides a display apparatus and a method for controlling the same, in which an adjustment item for adjusting a predetermined menu is simple thereby allowing a user to easily adjust the adjustment item.

The foregoing and/or other aspects of the present invention can be achieved by providing a method for controlling a display apparatus including a user selection unit which operates an adjustment item having at least one main adjustment item and at least one sub adjustment item corresponding to the main adjustment item, the method comprising: displaying each main adjustment item in one direction when a user adjustment function is selected through the user selection unit; and displaying the sub adjustment item in the same direction as the main adjustment item while distinguishing the sub adjustment item from the main adjustment item when the main adjustment item having the sub adjustment item is selected through the user selection unit.

According to an aspect of the invention, the displaying the sub adjustment item comprises displaying the sub adjustment item with a different size from the main adjustment item.

According to an aspect of the invention, the displaying the sub adjustment item comprises making the length of the main adjustment item become shorter with respect to one direction of arranging the adjustment items than a length of the main adjustment item before the sub adjustment item is displayed. Further, the displaying the sub adjustment item comprises making the length of the sub adjustment item become shorter in a direction transverse to the arranging direction of the main adjustment item than the length of the main adjustment item.

According to an aspect of the invention, the displaying of the sub adjustment item comprises displaying the adjustment item of the at least one main adjustment item and the at least one sub adjustment item, which is indicated through the user selection unit, distinguishably from a second adjustment item.

According to an aspect of the invention, the displaying the sub adjustment item comprises highlighting the adjustment item indicated through the user selection unit, and highlighting a new adjustment item when the new adjustment item is indicated through the user selection unit.

According to an aspect of the invention, the displaying the sub adjustment item comprises displaying the main adjustment item corresponding to the sub adjustment item distinguishably different from a second main adjustment item.

According to an aspect of the invention, the user selection unit comprises a bi-direction key, and the highlight position is changed as the adjustment item is newly indicated by selecting one direction of the bi-directional key.

According to an aspect of the invention, the total length of the main adjustment item and the sub adjustment item in an arranging direction of the adjustment items is constant regardless of whether the sub adjustment item is displayed.

Another aspect of the present invention can be achieved by providing a display apparatus, comprising: an interface image generating unit which generates an interface image comprising at least one main adjustment item and at least one sub adjustment item corresponding to the main adjustment item; a display unit which displays the interface image; a user selection unit which selects the adjustment item; and a control unit which controls the interface image generating unit to display each main adjustment item in a first direction when a user adjustment function is selected through the user selection unit, and to display the sub adjustment item in the first direction wherein the sub adjustment item is distinguishable from the main adjustment item when the main adjustment item having a predetermined sub adjustment item is selected through the user selection unit.

According to an aspect of the invention, the control unit controls the interface image generating unit such that a size of the sub adjustment item differs from a size of the main adjustment item.

According to an aspect of the invention, the control unit controls the interface image generating unit such that, when the sub adjustment item is displayed, the length of the main adjustment item becomes shorter in a direction of arranging the adjustment items than a length of the main adjustment item of before the sub adjustment item is displayed.

According to an aspect of the invention, the control unit controls the interface image generating unit such that when the sub adjustment item is displayed, the length of the sub adjustment item becomes shorter in a direction transverse to the arranging direction of the main adjustment item than the length of the main adjustment item.

### BRIEF DESCRIPTION OF THE DRAWINGS

The above and other aspects of the present invention will become apparent and more readily appreciated from the following description of the exemplary embodiments, taken in conjunction with the accompany drawings, in which:

FIG. 1 is a control block diagram of a display apparatus according to an exemplary embodiment of the present invention;

FIGS. 2A and 2B are views showing interface images displayed on a display unit of the display apparatus according to an exemplary embodiment of the present invention;

FIG. 3 is a control flowchart of the display apparatus according to an exemplary embodiment of the present invention; and

FIG. 4 illustrates bidirectional keys of a user selection unit according to an exemplary embodiment of the present invention.

### DETAILED DESCRIPTION OF THE EXEMPLARY EMBODIMENTS OF THE PRESENT INVENTION

Reference will now be made in detail to the embodiments of the present invention, examples of which are illustrated in the accompanying drawings, wherein like reference numerals refer to like elements throughout. The exemplary embodiments are described below so as to explain the present invention by referring to the figures.

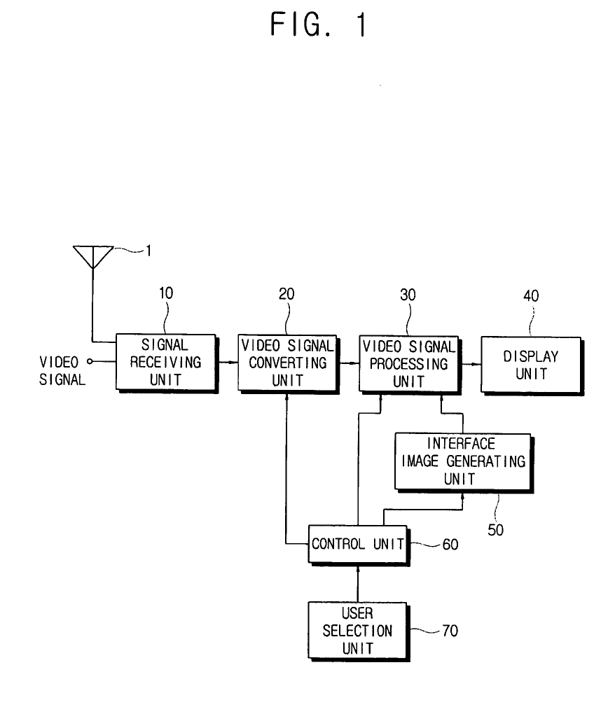

As shown in FIG. 1, a display apparatus according to an exemplary embodiment of the present invention comprises a display unit 40 on which an image is displayed; an interface image generating unit 50 for generating a predetermined interface image 51 to be displayed on the display unit 40; a user selection unit 70 for selecting a predetermined input signal; and a control unit 60 for controlling the above units. Further, the display apparatus according to the exemplary embodiment of the present invention can comprise a signal receiving unit 10 for receiving a predetermined video signal; a video signal converting unit 20 for converting the video signal received through the signal receiving unit 10; and a video signal processing unit 30 for processing the video signal converted in the video signal converting unit 20 so as to form an image to be displayed on the display unit 40.

The display unit 40 receives the video signal from the video signal processing unit 30 (to be described below) and displays an image thereon. The display unit 40 comprises a display panel (not shown) on which the image is displayed, and a panel driving unit (not shown) for processing the video signal transmitted from the video signal processing unit 30 and displaying the image on the display panel.

The video signal converting unit 20 converts the input video signal into a video signal which can be processed in the video signal processing unit 30. Here, the video signal converting unit 20 comprises a tuner (not shown) receiving and outputting a broadcast signal which is the radio frequency (RF) signal input through an antenna 1, and a video decoder (not shown) decoding an analog video signal, for example, a composite video baseband signal (CVBS) or S-video signal and the like input through a connection terminal (not shown) or the broadcast signal from the tuner and outputting the decoded signal to the video signal processing unit 30.

Also, the video signal converting unit 20 can comprise a transition minimized differential signaling (TMDS) receiving unit that divides a digital video signal such as a digital video interface (DVI) signal input from an outside terminal through a digital connecting terminal (not shown) into a RGB digital signal and a horizontal/vertical (H/V) synchronization signal and then outputting the divided signals to the video signal processing unit 30; and an analog/digital (A/D) converter (not shown) converting an analog video signal such as an input component signal or a PC signal into a digital video signal and then outputting the converted digital video signal to the video signal processing unit 30.

The video signal processing unit 30 processes the input video signal and outputs the processed signal for an image to be displayed on the display unit 40. Here, according to control of the control unit 60 (to be described below), the video signal processing unit 30 processes the video signal so that the display unit 40 displays not only an image corresponding to the video signal from the video signal converting unit 20 but also the interface image 51 corresponding to an interface video signal from the interface image generating unit 50 (to be described below). At this time, the interface image and the above image overlap each other.

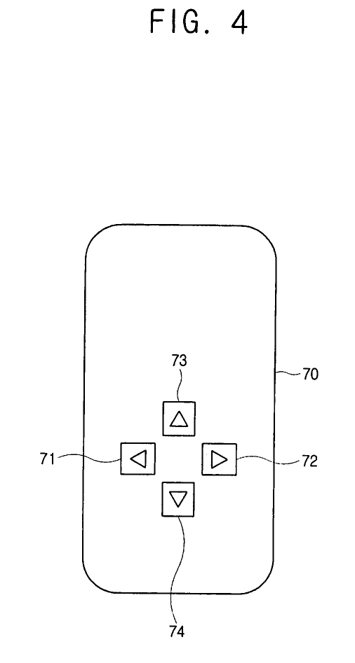

The user selection unit 70 outputs a predetermined key signal to the control unit 60 according to an operation selected by a user. The user selection unit 70 can comprise a bi-directional key used for selecting a user adjustment function. For example, as shown in FIG. 4, the user selection unit 70 can comprise a bi-directional key such as a left key 71, a right key 72, an up key 73 and a down key 74 or the like. Here, two directions of each bi-directional key are opposite to each other. Besides the bi-directional key, the user selection unit 70 can comprise at least one of a “MENU” key (not shown), an “ENTER” key (not shown) and an “EXIT” key, and can comprise a key signal generating unit (not shown) generating a key signal in response to an operation of the key. In an exemplary embodiment, a separate input means e.g., a mouse (not shown), a keyboard (not shown) or a wireless remote controller may be employed as the user selection unit 70. Here, once the user operates the button and the key, a key signal generating unit generates the key signal in response to an operation of the key and transmits the key signal to the control 60. To this end, the control unit 60 controls the video signal processing unit 30 and the interface image generating unit 50 in response to the key signal transmitted from the key signal generating unit.

The interface image generating unit 50 generates the interface image 51 on a screen of the display unit 40, the interface image comprising at least one adjustment item for adjusting conditions of the display apparatus. That is, the interface video signal output from the interface image generating unit 50 and corresponding to the interface image 51 is mixed with the video signal output from the video signal processing unit 30 and then displayed on the display unit 40. Here, the adjustment item may comprise at least one main adjustment item 53 and at least one sub adjustment item 55 corresponding to the main adjustment item 53.

Once the user adjustment function is selected through the user selection unit 70, the control unit 60 controls the interface image generating unit 50 and the video signal processing unit 30 to display each main adjustment item 53 in one direction. Further, once the main adjustment item 53 having a predetermined sub adjustment item 55 is selected through the user selection unit 70, the control unit 60 controls the interface image generating unit 50 and the video signal processing unit 30 to display the main adjustment item 53 and the sub adjustment item 55, which differs from the main adjustment item 53 in, for example, size, in the same direction.

In the case that the sub adjustment item 55 is displayed, the control unit 60 controls the width of the main adjustment item 53 to become narrower with respect to one direction of arranging the adjustment items than that of before the sub adjustment item 55 is displayed. At this time, the width of the main adjustment item 53 can be shortened in as if it is folded. Further, contrary to the main adjustment item 53, the width of the sub adjustment item 55 in the direction in which the adjustment items are arranged can be enlarged in a spreading-out manner. Also, in the case that the sub adjustment item 55 is displayed, the control unit 60 can control the interface image generating unit 50 such that the length of the sub adjustment item 55 is shorter than the length of the main adjustment item 53 in a direction transverse to the arranging direction thereof.

While a plurality of adjustment items including at least one main adjustment item 53 and at least one sub adjustment item 55 are displayed on the display unit 40, once the predetermined adjustment item is indicated to be displayed, through the user selection unit 70, the control unit 60 can control at least one of the video signal processing unit 30 and the interface image generating unit 50 to distinguish the indicated adjustment item from another adjustment item and display it. At this time, the indicated adjustment item can be displayed to be different from another adjustment item by being displayed in a different color or can be displayed in the form of a highlight image. Alternatively, the indicated adjustment item can be different from the other adjustment items in at least one of a brightness, a size, a thickness and a location of characters and the like.

For example, in the case that the indicated adjustment item is displayed in the form of a highlight image as compared with the other adjustment items, once another indicated adjustment item is selected by the bi-directional key of the user selection unit 70, the newly selected adjustment item is displayed in the form of a highlight image.

On the other hand, in the case that the sub adjustment item 55 is displayed on the display unit 40, the control unit 60 controls the main adjustment item 53 corresponding to the sub adjustment item 55 to be also distinguished from another main adjustment item and displayed on the display unit. For example, the main adjustment item 53 corresponding to the sub adjustment item 55 can be different from another main adjustment item in at least one of the brightness, the size, the thickness and the location of characters and the like.

In the meantime, even though a total number of the adjustment items is changed as the sub adjustment item 55 is displayed on the display unit 40, the control unit 60 can control the interface image generating unit 50 and the video signal processing unit 30 to make the total width of adjustment items a constant width with respect to their arranging direction.

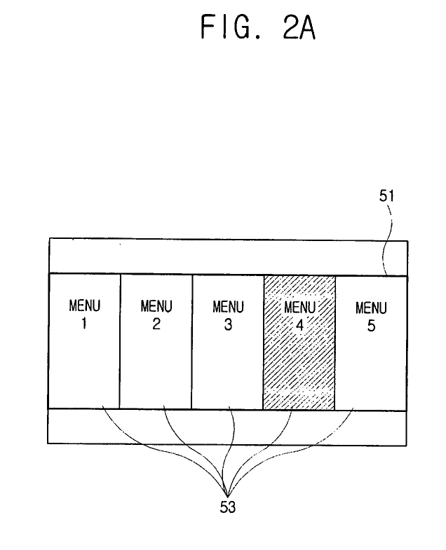

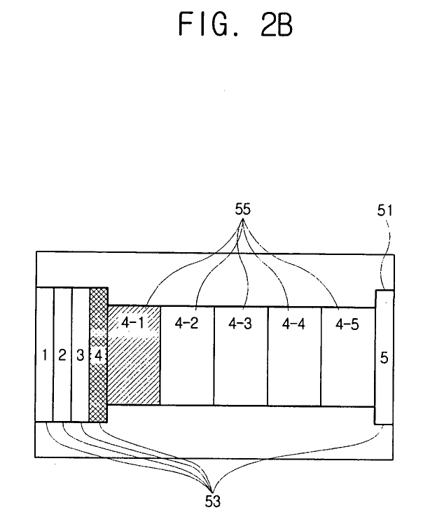

FIG. 2A and FIG. 2B are views showing the interface images displayed on the display unit 40 of the display apparatus according to an exemplary embodiment of the present invention.

As shown in FIG. 2A and FIG. 2B, in the display apparatus 40 according to an exemplary embodiment of the present invention, once the user adjustment function is selected through the user selection unit 70, the main adjustment items 53 are displayed on the display unit 40 in one direction. In this exemplary embodiment, the main adjustment items 53 are horizontally arranged. However, the main adjustment items 53 can be arranged in different directions such as a vertical direction and the like.

Further, as shown in FIG. 2A, the indicated main adjustment item 53 of the plurality of main adjustment items 53 can be displayed to be distinguishably different from another main adjustment item 53.

As shown in FIG. 2B, when one of the main adjustment items 53 is selected through the user selection unit 70, the sub adjustment item 55 corresponding to the selected main adjustment item 53 is displayed in the horizontal direction in which the main adjustment items 53 are arranged.

Once the menu 4 of the plurality of main adjustment items 53 displayed on the display unit 40 is selected, the sub adjustment items 55 corresponding to the menu 4 are displayed on the display unit 40. FIG. 2B shows that the sub adjustment item 55 corresponding to the menu 4 comprises five (5) items of 4-1, 4-2, 4-3, 4-4 and 4-5, as one exemplary embodiment.

Here, once the main adjustment item 53 corresponding to the indicated item 4-1 is indicated through the user selection unit 70, the item 4-1 of the indicated sub adjustment item 55 is displayed distinguishably so that the item 4-1 is distinguished from other items. Here, once the right key is selected in sequence through the user selection unit 70, the indication is moved sequentially in order of the item 4-2, item 4-3, item 4-4, item 4-5 (which belong to the sub adjustment item 55) and the menu 5 (which belongs to the main adjustment item 53), so that the indicated adjustment item is displayed to be distinguished from another adjustment item. Also, once the left key is selected in sequence, the indication is moved sequentially in order of the menu 4, menu 3, menu 2 and menu 1 which belongs to the main adjustment items 53, so that the indicated adjustment item is displayed to be distinguished from another adjustment item. Further, once the adjustment item indicated through the user selection unit 70 is selected by the selection button and the like, the interface image 51 corresponding to the adjustment item is displayed or a function corresponding to the adjustment item is performed.

Meanwhile, once the sub adjustment item 55 corresponding to the predetermined main adjustment item 53 is displayed, the main adjustment item 53 can be displayed to be distinguished from another main adjustment item. Here, as shown in FIG. 2B, once the sub adjustment item 55 corresponding to the menu 4 is displayed, the menu 4 can be displayed to be distinguished from another menu.

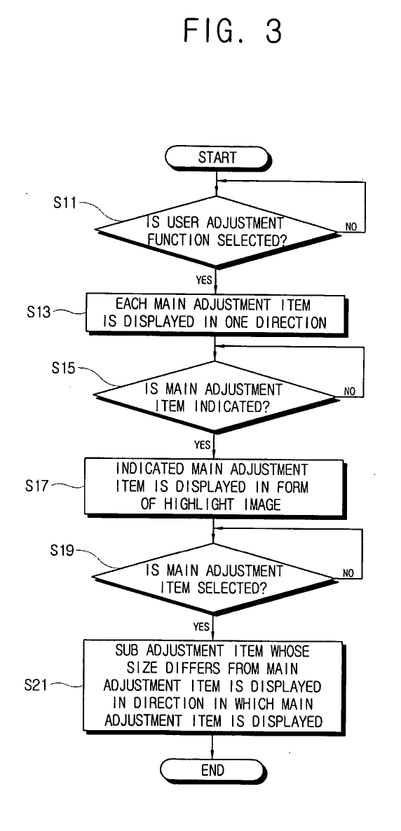

FIG. 3 is a control flow chart of the display apparatus according to an exemplary embodiment of the present invention.

In the display apparatus according to an exemplary embodiment of the present invention, as shown in FIG. 3, when the user adjustment function is selected through the user selection unit 70 at operation S11, each main adjustment item 53 is displayed to be oriented in one direction at operation S13.

After the main adjustment item 53 is displayed on the display unit 40, once one of the plurality of main adjustment items 53 is indicated at operation S15, the indicated main adjustment item 53 can be displayed distinguishably from another main adjustment item 53 at operation S17. At this time, as one example, the indicated main adjustment item 53 is displayed in the form of a highlight image.

After the main adjustment item 53 is displayed on the display unit 40, once the main adjustment item 53 having the predetermined sub adjustment items 55 is selected through the user selection unit 70 at operation S19, the sub adjustment item 55 is displayed in the direction in which the main adjustment item 53 is displayed at operation S21. At this time, the size of the sub adjustment item 55 differs from that of the main adjustment item 53. In the main adjustment item 53, once the sub adjustment item 55 is displayed, the width of each main adjustment item 53 is narrowed in its arranged direction. Also, the sub adjustment item 55 can be displayed while the length thereof is shortened in a direction transverse to the arranging direction of the main adjustment item 53.

In the display apparatus according to the foregoing exemplary embodiments of the present invention, a user can adjust freely the predetermined adjustment item using only the bidirectional key provided in the user selection unit 70. Thus, it is possible to simplify a complicated menu arrangement and the keys of the user selection unit as compared with the conventional apparatus. Accordingly, a user who has difficulty in operating complicated menus, such as the elderly, can easily adjust the menu.

As described above, the exemplary embodiments of the present invention provides the display apparatus and the method for controlling the same, in which a user adjustment menu is improved in simplification, so that users can easily operate the user adjustment menu.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method for controlling a display apparatus comprising a user selection unit which operates an adjustment item comprising at least one main adjustment item and at least one sub adjustment item corresponding to the main adjustment item, the method comprising:
displaying each main adjustment item in a first direction when a user adjustment function is selected through the user selection unit; and
displaying the sub adjustment item in the first direction while distinguishably displaying the sub adjustment item from the main adjustment item when the main adjustment item comprising the sub adjustment item is selected through the user selection unit.

2. The method according to claim 1, wherein the displaying the sub adjustment item comprises displaying the sub adjustment item in a different size from the main adjustment item.

3. The method according to claim 2, wherein the displaying the sub adjustment item comprises making a length of the main adjustment item become shorter with respect to the first direction of displaying the adjustment item than the length of the main adjustment item before the sub adjustment item is displayed.

4. The method according to claim 3, wherein the displaying the sub adjustment item comprises making a length of the sub adjustment item become shorter in a second direction, transverse to the first direction, than the length of the main adjustment item.

5. The method according to claim 4, wherein the displaying the sub adjustment item comprises displaying the adjustment item of the at least one main adjustment item and the at least one sub adjustment item, which is selected through the user selection unit, distinguishably from other main adjustment items and sub adjustment items.

6. The method according to claim 5, wherein the displaying the sub adjustment item comprises highlighting the adjustment item selected through the user selection unit, and highlighting a new adjustment item when the new adjustment item is indicated through the user selection unit.

7. The method according to claim 6, wherein the displaying the sub adjustment item comprises displaying the main adjustment item corresponding to the sub adjustment item distinguishably from the other main adjustment items.

8. The method according to claim 7, wherein the user selection unit comprises a bi-directional key, and the highlighting position is changed as a second adjustment item is newly indicated by selecting one direction of the bi-directional key.

9. The method according to claim 7, wherein the user selection unit comprises a bi-directional key which selects between the at least one main adjustment item and the at least one sub adjustment item.

10. The method according to claim 2, wherein a total length of the main adjustment item and the sub adjustment item in an arranging direction of the adjustment item is constant regardless of whether the sub adjustment item is displayed.

11. The method according to claim 2, wherein a total length of displaying the at least one main adjustment item and the at least one sub adjustment item in a first direction of the adjustment item is maintained a constant total length.

12. A display apparatus, comprising:
an interface image generating unit which generates an interface image comprising an adjustment item, wherein the adjustment item comprises at least one main adjustment item and at least one sub adjustment item corresponding to the main adjustment item;
a display unit which displays the interface image;
a user selection unit which selects the adjustment item; and
a control unit which controls the interface image generating unit to display each main adjustment item in a first direction when a user adjustment function is selected through the user selection unit, and to display the sub adjustment item in the first direction while distinguishably displaying the sub adjustment item from the main adjustment item when the main adjustment item having a predetermined sub adjustment item is selected through the user selection unit.

13. The display apparatus according to claim 12, wherein the control unit controls the interface image generating unit wherein a size of the sub adjustment item differs from a size of the main adjustment item.

14. The display apparatus according to claim 13, wherein the control unit controls the interface image generating unit wherein if the sub adjustment item is displayed, a length of the main adjustment item becomes shorter in the first direction than the length of the main adjustment item before the sub adjustment item is displayed.

15. The display apparatus according to claim 14, wherein the control unit controls the interface image generating unit wherein if the sub adjustment item is displayed, the length of the sub adjustment item becomes shorter, in a second direction, transverse to the first direction, than the length of the main adjustment item.

16. The display apparatus according to claim 12, wherein a total length of the main adjustment item and the sub adjustment item in the first direction of the adjustment item is maintained a constant total length.
